(19) United States
(12) Patent Application Publication
(10) Pub. No.: US 2008/0227056 A1
(43) Pub. Date: Sep. 18, 2008

(54) STENT FOR IMPLANT GUIDE AND PROSTHETICS

(75) Inventor: Ronald A. Bulard, Ardmore, OK (US)

Correspondence Address: NORRIS, MCLAUGHLIN & MARCUS, PA, 875 THIRD AVENUE, 18TH FLOOR, NEW YORK, NY, 10022, US

(73) Assignee: IMTEC, Ardmore, OK (US)

(21) Appl. No.: 12/047,140

(22) Filed: Mar. 12, 2008

Related U.S. Application Data
(60) Provisional application No. 60/906,405, filed on Mar. 12, 2007.

(51) Int. Cl. A61C 8/00; A61C 13/12

(52) U.S. Cl. 433/172; 433/75

(57) ABSTRACT

A method of virtually producing a dental stent for placing one or more dental implants based on data derived from scanning a patient's mouth and a prosthesis to be installed or an impression of the patient's existing teeth. The virtual dental stent is converted to a usable dental stent, which is, thereafter, used to guide the placement of the one or more dental implants into the patient's jawbone. After the dental implants have been placed, a prosthesis can be mounted onto the dental implants.

### CROSS-REFERENCE TO RELATED APPLICATION

This application claims priority pursuant to 35 U.S.C. §119(e) of U.S. Provisional Application No. 60/906,405, filed on Mar. 12, 2007.

### BACKGROUND OF THE INVENTION

1. Field of the Invention

The present invention relates to a stent for guiding the installation of dental implants and the seating of prosthetics on the installed implants.

2. Description of Related Art

U.S. Pat. No. 5,967,777 (hereinafter “Klein”) discusses in the Background section thereof various problems encountered previously in installing implants and thereafter proposes a possible solution thereto. Typically, a dentist uses a handheld drill to make a hole in the patient's jawbone at the site that is to receive the dental implant. That hole needs to have a defined trajectory, depth and diameter. These parameters, in turn, depend upon the anticipated position of the patient's teeth to be replaced and supported by the dental implant(s) and, also, the existing anatomical structures, e.g., jawbone height and width, proximity to nerves, existing tooth roots and sinus cavities.

The recommended procedure for installing dental implants involves using a template as a guide to assist the dentist in positioning and angling the dental implants during installation. Fabrication of the template typically includes the following steps:
1) Making a plastic replica of the prospective teeth; and
2) Making hole(s) in the plastic replica in the approximate area where the dentist anticipates he or she will be placing the implant(s) and with the anticipated proper angulation for the installation.

A computed tomography scan (CT scan) can be employed to improve the accuracy of the hole positioning and angulation. In particular, cone beam computed tomography (CBCT) produces a highly accurate scan of the patient's head and neck which is initially recorded in a DICOM file (Digital Imaging and Communication) and then fed into a software program which depicts the anatomy of the patient in 3-dimensions.

There are a number of excellent software programs publicly available that enable the dentist to use the CBCT scan to generate 3-dimensional views of the actual anatomy of the patient. The anatomy can be viewed in many different planes to provide a precise knowledge of the disposition of anatomical structures. These views enable the dentist to devise a treatment plan for the ideal placement of dental implants. They also enable the dentist to select the most appropriate implant form, length, diameter and degree of angulation.

According to Klein, all these previous methods suffer from the drawbacks that the hole(s) in the plastic replica are ultimately drilled by hand by the dentist and this introduces the element of human error.

Klein's solution involves the use of a computer-driven milling machine to drill the hole(s) in the plastic replica, thereby improving the accuracy of the entire process. A plastic replica of the teeth to be inserted is made, marked with fuducial markers and positioned in the patient's mouth. Thereafter, a CT scan is made of the patient's mouth with the plastic replica inside. Software is then used to superimpose the optimal positioning and angulation of simulated dental implants at the installation site. Data for the optimal positioning and angulation is then imported to the computer-driven milling machine, which then drills the corresponding hole(s) in the plastic replica. The dentist then installs the dental implant(s) through the hole(s) in the plastic replica. Once the dental implant(s) have been installed, they can be loaded with the prosthesis.

Problems with Klein's approach include the fact that it is complicated and, also, the fact that it requires the dentist to make a plastic replica of the teeth to be replaced before his inventive procedure is begun.

Accordingly, there remains a need in the art to provide a simpler dental implant installation protocol that is highly accurate and avoids the need to prepare a plastic replica of the replacement teeth beforehand.

Stereolithography is a well-known rapid manufacturing and rapid prototyping technology for producing parts with high accuracy and good surface finish. A device that performs stereolithography is called a stereolithography apparatus (hereinafter “STL printer”). Basically, stereolithography is an additive fabrication process that utilizes a vat of liquid UV-curable photopolymer “resin” and a UV laser to build parts a layer at a time. On each layer, the laser beam traces a part cross-section pattern on the surface of the liquid resin. Exposure to the UV laser light cures or solidifies the pattern traced on the resin and adheres it to the layer below. Layers are built up sequentially until a complete 3-dimensional part is formed. After building, parts are cleaned of excess resin by immersion in a chemical bath and then cured in a UV oven.

3-Dimensional parts may be made by other techniques, for example, milling machines.

### SUMMARY OF THE INVENTION

These and other objects were met with the present invention, which relates in a first embodiment to a method of producing a dental stent for use in placing a dental implant into a patient's jawbone, wherein the method comprises:
a) providing a prosthesis to be inserted into the patient's mouth or an impression of at least a portion of the patient's upper or lower jawbone;
b) labeling said prosthesis or impression with at least one marker;
c) making a scan of the prosthesis or the impression in the patient's mouth to compile data of the seated prosthesis or the impression registering the at least one marker relative to patient's jawbone;
d) making a scan of the prosthesis or the impression separate from the patient's mouth to compile data of the unseated prosthesis or impression;
e) using the seated and unseated prosthesis or impression data to produce a virtual design of a dental stent, wherein the virtual design of the dental stent embodies a treatment plan for placing the dental implant into the patient's jawbone; and
f) converting the virtual design to a usable dental stent.

The term “marker” as used herein encompasses anything capable of making the prosthesis or impression visible and identifiable during the scan.

The term “treatment plan” as used herein includes implant selection, positioning of the implant on the patient's jawbone, and depth and angulation of the drilling procedure.

The invention relates in a second embodiment to a method of installing a dental implant into a patient's jawbone, wherein the method comprises:
a) producing a dental stent according to the inventive method outlined above;
b) positioning the dental stent in the patient's mouth;
c) drilling at least one pilot hole into the patient's jawbone using the dental stent as a guide; and
d) installing the dental implant into the patient's jawbone through the pilot hole.

The invention relates in a third embodiment to a method of placing a dental prosthesis into a patient's mouth, wherein the method comprises:
a) installing a dental implant into the patient's jawbone according to the inventive method outlined above; and
b) securing the dental prosthesis to the dental implant.

### BRIEF DESCRIPTION OF THE DRAWINGS

The invention will now be described in greater detail with reference to the drawings, wherein:

FIG. 1 is a schematic showing dental stent 10 being used as a guide for drills 11 and 12 into the jawbone 13 of a patient with missing teeth.

FIG. 2 is a schematic showing dental implants 21 and 22 being placed through dental stent 10 into the jawbone 13 of the patient of FIG. 1.

FIG. 3 is a schematic showing dental stent 10 being used as a guide for drills 11 and 12 into bridge 31.

FIG. 4 is a schematic showing dental stent 10 being used as a guide for drills 11 and 12 into edentulous jawbone 41.

FIG. 5 is a schematic showing dental implants 21 and 22 being placed through dental stent 10 into edentulous jawbone 41.

FIG. 6 is a schematic showing dental stent 10 being used as a guide for drills 11 and 12 into denture 61.

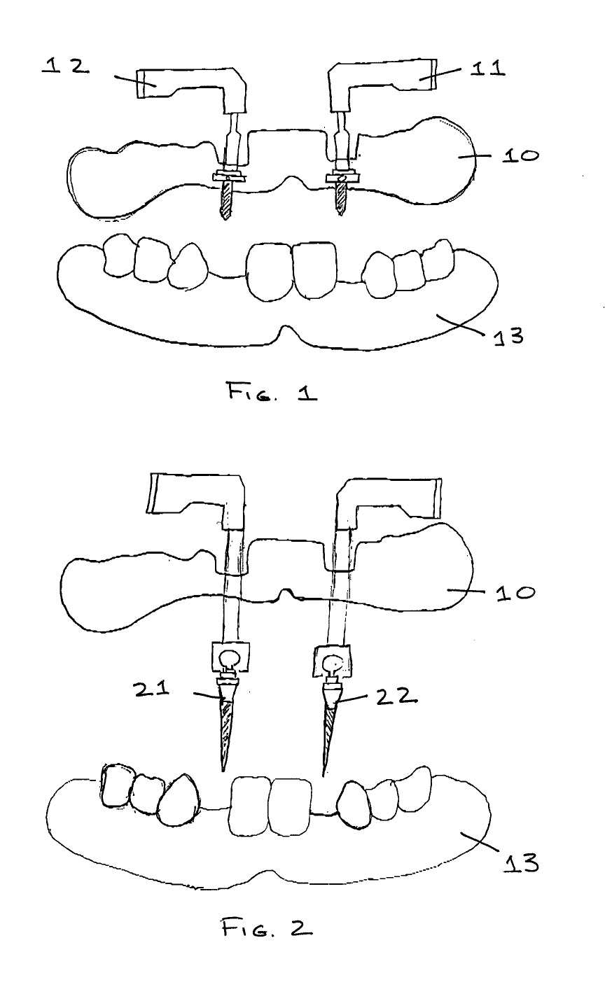

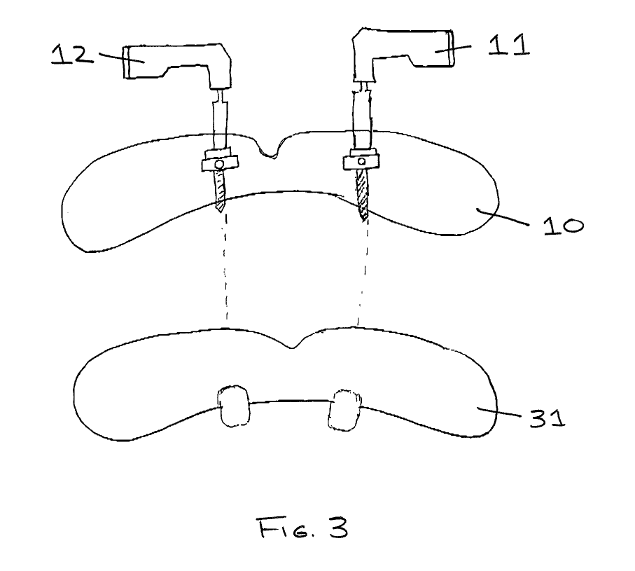

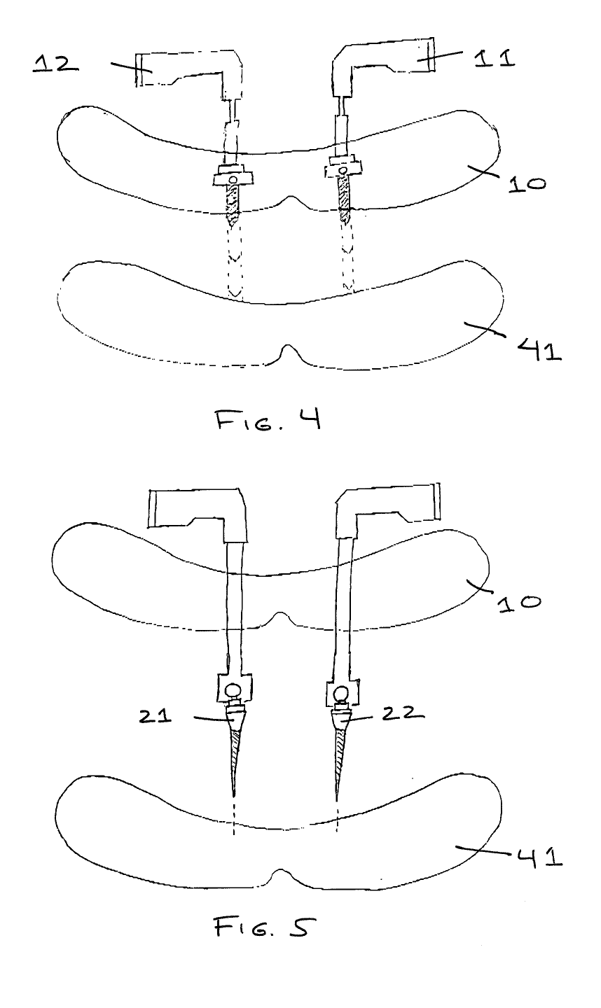

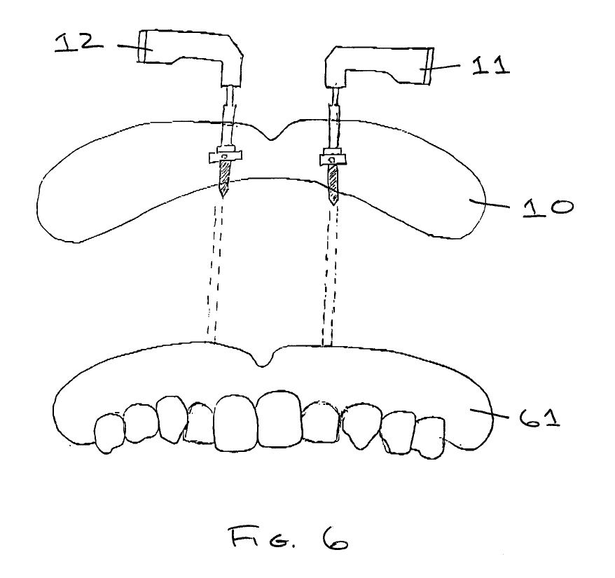

### DETAILED DESCRIPTION OF THE INVENTION

According to the present invention, scan data from a patient's mouth and a prosthesis or impression is used to construct a virtual model of a dental stent for placing one or more dental implants into the patient's jawbone. That virtual model is then converted to a usable 3-dimensional dental stent. The 3-dimensional dental stent is then used as a guide to place the dental implant(s) into the patient's jawbone with a high degree of accuracy as to the positioning of the implants into the patient's jawbone and with the correct angulation.

In one embodiment, the virtual model of the dental step is made using a prosthesis.

In another embodiment, the prosthesis is a denture. The denture may be, for example, a newly created denture. Alternatively, the denture may be a preexisting denture intended to be reseated in the patient's jawbone.

In another embodiment, the virtual model of the dental step is made using an impression of at least a portion of the patient's upper or lower jawbone. In a preferred embodiment, the impression is of at least a portion of the patient's upper or lower jawbone having at least one natural tooth.

Having provided the prosthesis or the impression, the prosthesis or the impression is labeled with one or a plurality of markers. As indicated above, term “marker” encompasses anything capable of making the prosthesis or impression visible and identifiable during the scan. Suitable markers include, without limitation, fiducial markers or radiopaque markers. These may be incorporated onto or into the prosthesis or the impression according to methods well known to persons skilled in the art. Suitable fiducial markers and methods for introducing them onto or into prostheses and impressions are well known to persons skilled in the art, for example, from the Klein patent discussed above and the prior art discussed therein, and these details are not repeated here, but, instead, the Klein reference and the pertinent details are incorporated herein fully by reference. Suitable radiopaque materials, for example, barium sulfate solutions, are also well known to persons skilled in the art. Where, for example, a barium sulfate solution is used, the solution can be incorporated into the prosthesis or the impression, or else the prosthesis or the impression can be coated with the solution. In addition, the markers may comprise magnetic materials, optical materials or combinations thereof, so long as the marker renders the prosthesis or the impression visible and identifiable during the scan.

Scans are made of the patient's mouth with the prosthesis or impression properly positioned in place (“seated”), and, also, of the separate prosthesis or impression (“unseated”). The scan can be made using any suitable intra-oral scanning method capable of forming a suitable data set providing sufficient information for forming the dental stent. Preference is given to ct cone beam x-ray scanning or light scanning, with ct cone beam x-ray scanning being particularly preferred.

The seated and unseated data is fed into a computer program and used to design a virtual model of the 3-dimensional dental stent. Suitable computer programs are known in the art or capable of being designed. Preference is for the IlumaVision 3D™ program, soon to be available from Imtec Corporation. The dental stent embodies the treatment plan for installing the dental implant(s) and comprises a guide for proper placement and angulation of the dental implant(s) into the patient's jawbone. In an especially preferred embodiment, the dental stent also comprises a guide for a making a hole in a prosthesis to be seated on the dental implant(s).

Virtual data compiled on the construction of the dental stent are fed to a device which is capable of converting the virtual dental stent design into a usable 3-dimensional dental stent. A number of such devices are already known in the art. One such device is the STL printer mentioned above. Another such device is the milling machine, also discussed above. Preferably, a STL printer is used.

As desired, the stent can be a single, integrated piece or else may comprise a plurality of pieces that may be joined together or positioned relative to one another to achieve the desired construct. For example, the stent may have one insert for drilling the pilot hole into the implant placement site, another for drilling a larger diameter implant placement hole, if desired, and yet another insert adapted to facilitate installation of the implant itself through the stent. Alternatively, separate stent pieces may be joined together, for example, by a hinge, in such a way as to provide the proper diameter holes and angulation, which pieces, because they are separate, can be easily moved as necessary to facilitate implant installation.

The dental stent is thereafter positioned in the patient's mouth and properly positioned. Using the dental stent as a guide, at a minimum a small starter bore is drilled into the patient's jawbone. Thereafter, the starter hole may be enlarged as desired or not, and then the implant is at least partially installed through the starter hole into the patient's jawbone. In a preferred embodiment, the dental stent remains in place in the patient's mouth for at least a part of time the dental implant is being screwed into the patient's jawbone.

Once the dental implant has been installed, the dental implant can be loaded with temporary or permanent prostheses as is well known in the art.

The dental implant may be any type of implant known in the art. Preference is, however, given to small diameter implants, for example, as are disclosed in U.S. Pat. Nos. 5,749,732; 6,716,030; and 7,112,063; and U.S. Pre-Grant Publication Nos. 2006/0269903; and 2006/0275,735; the entire contents of which patents and published applications are hereby incorporated fully by reference as to the implant design, type, composition and dimensions and the implant insertion protocols.

The term “small diameter implant” as used herein means an implant less than 4.0 mm in diameter, preferably less than 3.5 mm in diameter, especially less than 2.0 mm in diameter. Small diameter implants permit insertion of the implant directly through the soft tissue into the underlying bone without any flap surgery incisions or sutures making for a much more patient-friendly procedure than is typical of larger size implant systems. In a particularly preferred insertion procedure, using the inventive dental stent, a pilot hole about 4 to 8 mm in length is drilled directly through the patient's gum and into the jawbone therebelow. Using the inventive dental stent as a guide, a dental implant having a diameter greater than that of the pilot hole is then installed through said pilot hole into the patient's jawbone.

In a preferred embodiment, the dental implant extends between a first end and a second end, and comprises the following distinct regions formed into one piece:
a) a threaded shaft tapering to a point at the first end;
b) a head at the second end, the head permitting a dental prosthesis to be mounted thereon; and
c) optionally a non-circular abutment positioned between the threaded shaft and the head.

In one especially preferred embodiment, the dental implant head is ball-shaped.

In another especially preferred embodiment, the dental implant head is other than ball-shaped.

In another especially preferred embodiment, the dental implant has a non-circular abutment positioned between the threaded shaft and the head.

In another especially preferred embodiment, the dental implant lacks a non-circular abutment positioned between the threaded shaft and the head.

In the most preferred embodiment, the dental implant in each of the foregoing embodiments is a small diameter dental implant.

Without being limiting, exemplary protocols for preparing the inventive dental stent in terms of patient type are set forth below:

### Exemplary Protocols for Creating Surgical Stent

### Edentulous Patient

1) Introduce fiducial markers onto/into patient's new or existing denture to create at least one reference point.
2) Scan the denture in the patient's mouth to register the reference point with the natural anatomy of the patient's jawbone and soft tissue.
3) Scan denture separately, or make impression from denture and scan impression separately. Use a higher intensity of x-ray to get highest resolution digital data.
4) Treatment plan implantation procedure in software program according to the digital data derived from scanning denture in patient's mouth and denture/impression separately.
5) Design stent in software program that accommodates the treatment plan (including depth and angulation of drilling procedure, selection of implant, prosthetic device).
6) Print out surgical stent on STL printer.
   Patient with at Least One Natural Tooth
1) Take impression of patient's upper and lower teeth.
2) Introduce fiducial markers into the impression or register off of an anatomical landmark.
3) Scan the impression in the patient's mouth to register the fiducial markers with the natural anatomy of the patient's jawbone and soft tissue.
4) Scan impression separately. Use a higher intensity of x-ray to get highest resolution digital data.
5) Treatment plan implantation procedure in software program according to the digital data derived from scanning impression in patient's mouth and impression separately.
6) Design stent in software program that accommodates the treatment plan (including depth and angulation of drilling procedure, selection of implant, prosthetic device).
7) Print out surgical stent on STL printer.

While the present invention has been described in conjunction with the specific embodiments set forth above, many alternatives, modifications and other variations thereof will be apparent to those of ordinary skill in the art. All such alternatives, modifications and variations are intended to fall within the spirit and scope of the present invention.

What is claimed is:

1. A method of producing a dental stent for use in placing a dental implant into a patient's jawbone, said method comprising the steps of:
a) providing a prosthesis to be inserted into the patient's mouth or an impression of at least a portion of the patient's upper or lower jawbone;
b) labeling said prosthesis or impression with at least one marker;
c) making a scan of the prosthesis or the impression in the patient's mouth to compile data of the seated prosthesis or the impression registering the at least one marker relative to patient's jawbone;
d) making a scan of the prosthesis or the impression separate from the patient's mouth to compile data of the unseated prosthesis or impression;
e) using the seated and unseated prosthesis or impression data to product a virtual design of a dental stent, wherein the virtual design of the dental stent embodies a treatment plan for placing the dental implant into the patient's jawbone; and
f) converting the virtual design to a usable dental stent.

2. The method according to claim 1, wherein in step a) comprises providing a prosthesis.

3. The method according to claim 2, wherein the prosthesis is a denture.

4. The method according to claim 3, wherein the denture is a newly created denture.

5. The method according to claim 3, wherein the denture is a preexisting denture intended to be reseated in the patient's jawbone.

6. The method according to claim 1, wherein step a) comprises providing an impression of at least a portion of the patient's upper or lower jawbone.

7. The method according to claim 6, wherein the impression is of at least a portion of the patient's upper or lower jawbone having at least one natural tooth.

8. The method according to claim 1, wherein a plurality of fiducial markers are introduced onto or into the prosthesis or impression.

9. The method according to claim 1, wherein a radiopaque material is introduced onto or into the prosthesis or impression.

10. The method according to claim 1, wherein the scan of the patient's mouth and/or prosthesis or impression is one of a ct cone beam x-ray scan or a light scan.

11. The method according to claim 10, wherein the scan is a ct cone beam x-ray scan.

12. The method according to claim 1, wherein the virtual design is converted to a usable dental stent by printing on a STL printer.

13. The method according to claim 1, wherein the virtual design is converted to a usable dental stent by milling with a milling machine.

14. The method according to claim 1, wherein the dental stent comprises a guide for proper placement and angulation of the dental implant into the patient's jawbone.

15. The method according to claim 1, wherein the dental stent comprises a guide for a making a hole in a prosthesis to be seated on the implant.

16. A method of installing a dental implant into a patient's jawbone, said method comprising the steps of:
a) producing a dental stent according to the method of claim 1;
b) positioning the dental stent in the patient's mouth;
c) drilling at least one pilot hole into the patient's jawbone using the dental stent as a guide; and
d) installing the dental implant into the patient's jawbone through said pilot hole.

17. The method according to claim 16, wherein the pilot hole is drilled through the patient's gum into the jawbone below.

18. The method according to claim 16, wherein the dental implant is a small diameter implant.

19. The method according to claim 16, wherein the dental implant extends between a first end and a second end, and comprises the following distinct regions formed into one piece:
a) a threaded shaft tapering to a point at said first end;
b) a head at said second end, said head permitting a dental prosthesis to be mounted thereon; and
c) optionally a non-circular abutment positioned between said threaded shaft and said head.

20. The method according to claim 19, wherein said head is ball-shaped.

21. The method according to claim 19, wherein said head is other than ball-shaped.

22. The method according to claim 19, wherein the dental implant has a non-circular abutment positioned between said threaded shaft and said head.

23. The method according to claim 19, wherein the dental implant lacks a non-circular abutment positioned between said threaded shaft and said head.

24. A method of placing a dental prosthesis into a patient's mouth, said method comprising the steps of:
a) installing a dental implant into the patient's jawbone according to the method of claim 19; and
b) securing the dental prosthesis to said dental implant.

25. The method according to claim 24, wherein the dental prosthesis is a denture.

26. A dental stent produced according to the method of claim 1.
